(19) United States
(12) Patent Application Publication
(10) Pub. No.: US 2012/0272468 A1
(43) Pub. Date: Nov. 1, 2012

(54) Oral Care Device Comprising A Synthetic Polymer Derived From A Renewable Resource And Methods Of Producing Said Device

(75) Inventors: Paul Thomas Weisman, Cincinnati, OH (US); John Christian Haught, West Chester, OH (US); Bryn Hird, Cincinnati, OH (US)

(73) Assignee: The Procter & Gamble Company, Cincinnati, OH (US)

(21) Appl. No.: 13/094,029

(22) Filed: Apr. 26, 2011

(51) Int. Cl. A46B 9/04; B67D 7/00

(52) U.S. Cl. 15/167.1; 222/173

(57) ABSTRACT

An oral care device is disclosed including a body. The body is formed at least partially from a first polymer and the first polymer is synthetic and at least partially derived from a renewable resource via a first intermediate monomeric compound. The body includes one or more components such that at least one component of the body has a bio-based content of about 10% to about 100% using ASTM D6866-10, method B. Methods of forming oral care devices are also provided.

### FIELD OF THE INVENTION

The present disclosure generally relates to oral care devices and, more particularly, to oral care devices which comprise synthetic polymeric materials derived from renewable resources, where the materials have specific performance characteristics making them particularly useful in oral care devices. The present disclosure also relates to oral care dispensers and, more particularly, oral care dispensers which comprise synthetic polymeric materials derived from renewable resources.

### BACKGROUND OF THE INVENTION

Oral care devices, such as toothbrushes (manual and power), generally include a handle and a cleaning section or head portion. Because of widely differing consumer tastes, manufacturers tend to make a wide variety of oral care devices. The development of oral care devices is the subject of substantial commercial interest. In particular, a great deal of effort has been spent in the development of materials exhibiting optimal performance characteristics for use in oral care devices.

Most of the materials used in current commercial oral care devices, especially the handle, are derived from non-renewable resources, especially petroleum. Typically, the components of the oral care devices are made from polyolefins such as polyethylene and polypropylene. These polymers are derived from olefinic monomers such as ethylene and propylene which are obtained directly from petroleum via cracking and refining processes. Similarly, oral care dispensers, such as tubes or bottles, are blow molded from a plastic material such as polyethylene.

Thus, the price and availability of the petroleum feedstock ultimately has a significant impact on the price of oral care devices which utilize materials derived from petroleum. As the worldwide price of petroleum escalates, so does the price of oral care devices.

Furthermore, many consumers display an aversion to purchasing products that are derived from petrochemicals. In some instances, consumers are hesitant to purchase products made from limited non-renewable resources such as petroleum and coal. Other consumers may have adverse perceptions about products derived from petrochemicals being “unnatural” or not environmentally friendly.

Accordingly, it would be desirable to provide oral care devices which comprise a polymer at least partially derived from renewable resources, where the polymer has specific performance characteristics making the polymer particularly useful in oral care devices. It is also desirable to provide oral care dispensers which comprise a polymer at least partially derived from renewable resources, where the polymer has specific performance characteristics making the polymer particularly useful in oral care dispensers.

### SUMMARY OF THE INVENTION

In accordance with one embodiment, an oral care device is provided. The oral care device includes a) a body and b) at least one contact element extending from the body. The body is formed at least partially from a first polymer derived from a first renewable resource via at least one first intermediate compound. The first polymer is synthetic and the first intermediate compound is monomeric. The first polymer is disposed in or incorporated into one or more components of the body, the components selected from a group consisting of a handle, a cleaning head portion, a neck and a grip portion. Further, at least one component of the body has a bio-based content of about 10% to about 100% using ASTM D6866-10, method B.

In accordance with another embodiment, an oral care device is provided. The oral care device includes a) a handle; b) a cleaning section having at least one contact element extending therefrom; and c) a first polymer derived from a first renewable resource via at least one first intermediate compound, the first polymer being synthetic, and the first intermediate compound being monomeric, and at least one of the handle and the cleaning section having a bio-based content of about 10% to about 100% using ASTM D6866-10, method B.

In accordance with another embodiment, a method for making an oral care device is provided. The method includes the steps of: a) providing a renewable resource; b) deriving an intermediate monomeric compound from the renewable resource; c) polymerizing the monomeric compound to form a synthetic polymer, and d) disposing or incorporating the polymer into one or more components of the oral care device, the components selected from a group consisting of a handle, a cleaning section, a cleaning head portion, a neck, and a grip portion.

In accordance with one embodiment, a blow molded oral care dispenser is provided. The dispenser includes a body having a closed bottom end, the body formed at least partially from a first polymer derived from a first renewable resource via at least one first intermediate compound. The first polymer is synthetic and the first intermediate compound is monomeric. The body has a bio-based content of about 10% to about 100% using ASTM D6866-10, method B.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, where like structure is indicated with like reference numerals and in which:

FIG. 1 is a perspective view of an electric oral care device according to one embodiment;

FIG. 2 is a perspective view of a cleaning section for an electric oral care device according to one embodiment;

FIG. 3 is a side view of a manual oral care device according to one embodiment; and

FIG. 4 is a perspective view of an oral care dispenser according to one embodiment.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

### I. Definitions

As used herein, the following terms shall have the meaning specified thereafter:

“Bio-based content” refers to the amount of carbon from a renewable resource in a material as a percent of the mass of the total organic carbon in the material, as determined by ASTM D6866-10, method B. Note that any carbon from inorganic sources such as calcium carbonate is not included in determining the bio-based content of the material.

“Petrochemical” refers to an organic compound derived from petroleum, natural gas, or coal.

“Petroleum” refers to crude oil and its components of paraffinic, cycloparaffinic, and aromatic hydrocarbons. Crude oil may be obtained from tar sands, bitumen fields, and oil shale.

“Renewable resource” refers to a natural resource that can be replenished within a 100 year time frame. The resource may be replenished naturally, or via agricultural techniques. Renewable resources include plants, animals, fish, bacteria, fungi, and forestry products. They may be naturally occurring, hybrids, or genetically engineered organisms. Natural resources such as crude oil, coal, and peat which take longer than 100 years to form are not considered to be renewable resources.

“Agricultural product” refers to a renewable resource resulting from the cultivation of land (e.g. a crop) or the husbandry of animals (including fish).

“Monomeric compound” refers to an intermediate compound that may be polymerized to yield a polymer.

“Polymer” refers to a macromolecule comprising repeat units where the macromolecule has a molecular weight of at least 1000 Daltons. The polymer may be a homopolymer, copolymer, terpoymer etc. The polymer may be produced via fee-radical, condensation, anionic, cationic, Ziegler-Natta, metallocene, or ring-opening mechanisms. The polymer may be linear, branched and/or crosslinked.

“Synthetic polymer” refers to a polymer which is produced from at least one monomer by a chemical process. A synthetic polymer is not produced directly by a living organism.

“Polyethylene” and “polypropylene” refer to polymers prepared from ethylene and propylene, respectively. The polymer may be a homopolymer, or may contain up to about 10 mol % of repeat units from a co-monomer.

“Communication” refers to a medium or means by which information, teachings, or messages are transmitted.

“Related environmental message” refers to a message that conveys the benefits or advantages of the oral care device comprising a polymer derived from a renewable resource. Such benefits include being more environmentally friendly, having reduced petroleum dependence, being derived from renewable resources, and the like.

“Oral care device” refers to any implement, device, tool and/or applicator which can be utilized for improving and/or altering oral cleanliness and/or hygiene. Non-limiting examples include, toothbrushes (both manual and power), dental explorers, flossing devices, water picks, irrigators, tooth polishers, gum massagers, light pens, and the like.

“Oral care composition” refers to a product, which in the ordinary course of usage, is not intentionally swallowed for purposes of systematic administration of particular therapeutic agents, but is rather retained in the oral cavity for a time sufficient to contact substantially all of the dental surfaces and/or oral tissues for purposes of oral activity. The oral care compositions may be in various forms including toothpaste, dentifrice, tooth gel, subgingival gel, mouthrinse, mousse, foam, denture product, or mouthspray.

“Dentifrice” refers to paste, gel or liquid formulations unless otherwise specified. The dentifrice composition may be a single phase composition or may be a combination of two or more separate dentifrice compositions.

“Oral care dispenser” refers to any pump, tube, bottle or container suitable for dispensing oral care compositions.

II. Polymers Derived from Renewable Resources

A number of renewable resources contain polymers that are suitable for use in an oral care device (i.e., the polymer is obtained from the renewable resource without intermediates). Suitable extraction and/or purification steps may be necessary, but no intermediate compound is required. Such polymers derived directly from renewable resources include cellulose (e.g. pulp fibers), starch, chitin, polypeptides, poly(lactic acid), polyhydroxyalkanoates, and the like. These polymers may be subsequently chemically modified to improve end use characteristics (e.g., conversion of cellulose to yield carboxycellulose or conversion of chitin to yield chitosan). However, in such cases, the resulting polymer is a structural analog of the starting polymer. Polymers derived directly from renewable resources (i.e., with no intermediate compounds) and their derivatives are known and these materials are not within the scope of the present disclosure.

Synthetic polymers of the present disclosure can be derived from a renewable resource via an indirect route involving one or more intermediate compounds. Suitable intermediate compounds derived from renewable resources include sugars. Suitable sugars include monosaccharides, disaccharides, trisaccharides, and oligosaccharides. Sugars such as sucrose, glucose, fructose, maltose may be readily produced from renewable resources such as sugar cane and sugar beets. Sugars may also be derived (e.g., via enzymatic cleavage) from other agricultural products such as starch or cellulose. For example, glucose may be prepared on a commercial scale by enzymatic hydrolysis of corn starch. While corn is a renewable resource in North America, other common agricultural crops may be used as the base starch for conversion into glucose. Wheat, buckwheat, arracaha, potato, barley, kudzu, cassava, sorghum, sweet potato, yam, arrowroot, sago, and other like starchy fruit, seeds, or tubers are may also be used in the preparation of glucose.

Other suitable intermediate compounds derived from renewable resources include monofunctional alcohols such as methanol or ethanol and polyfunctional alcohols such as glycerol. Ethanol may be derived from many of the same renewable resources as glucose. For example, cornstarch may be enzymatically hydrolyzed to yield glucose and/or other sugars. The resultant sugars can be converted into ethanol by fermentation. As with glucose production, corn is an ideal renewable resource in North America; however, other crops may be substituted. Methanol may be produced from fermentation of biomass. Glycerol is commonly derived via hydrolysis of triglycerides present in natural fats or oils, which may be obtained from renewable resources such as animals or plants.

Other intermediate compounds derived from renewable resources include organic acids (e.g., citric acid, lactic acid, alginic acid, amino acids etc.), aldehydes (e.g., acetaldehyde), and esters (e.g., cetyl palmitate, methyl stearate, methyl oleate, etc.).

Additional intermediate compounds such as methane and carbon monoxide may also be derived from renewable resources by fermentation and/or oxidation processes.

Other intermediate compounds such as carbon dioxide and carbon monoxide may be converted into polymers, for example polypropylene carbonate, by combining CO₂ or CO and propylene oxide in the presence of a catalyst available from Novomer, Inc.

Intermediate compounds derived from renewable resources may be converted into polymers (e.g., glycerol to polyglycerol) or they may be converted into other intermediate compounds in a reaction pathway which ultimately leads to a polymer useful in an oral care device. An intermediate compound may be capable of producing more than one secondary intermediate compound. Similarly, a specific intermediate compound may be derived from a number of different precursors, depending upon the reaction pathways utilized.

Particularly desirable intermediates include olefins. Olefins such as ethylene and propylene may also be derived from renewable resources. For example, methanol derived from fermentation of biomass may be converted to ethylene and or propylene, which are both suitable monomeric compounds, as described in U.S. Pat. Nos. 4,296,266 and 4,083,889. Ethanol derived from fermentation of a renewable resource may be converted into the monomeric compound ethylene via dehydration as described in U.S. Pat. No. 4,423,270. Similarly, propanol or isopropanol derived from a renewable resource can be dehydrated to yield the monomeric compound of propylene as exemplified in U.S. Pat. No. 5,475,183. Propanol is a major constituent of fusel oil, a by-product formed from certain amino acids when potatoes or grains are fermented to produce ethanol. In one embodiment, polyethylene is “bio-sourced PE”, that is, it has been derived from a renewable resource, rather than from oil. In one example, sugar cane is fermented to produce alcohol. The alcohol is dehydrated to produce ethylene gas. This ethylene gas is then put through a polymerization reactor in the same way that any ethylene gas derived from oil could be put through a polymerization reactor. Bio-sourced polyethylene can be made from other plants, for example, sugar beet/molasses/cellulose. Bio-sourced polyethylene has the same physical properties as oil-based polyethylene, providing it has been polymerized under the same reactor conditions as the oil-sourced polyethylene. In another embodiment, polyethylene can be produced from renewable ethene as described below. Renewable ethane may be produced from a renewable raw material, such as ethanol. Ethanol is renewable when it is produced from a reproducible resource. Ethanol is produced from the renewable ethanol by dehydrating ethanol for instance.

Charcoal derived from biomass can be used to create syngas (i.e., CO+H₂) from which hydrocarbons such as ethane and propane can be prepared (Fischer-Tropsch Process). Ethane and propane can be dehydrogenated to yield the monomeric compounds of ethylene and propylene.

Polyethylene terephthalate and its copolyesters (“PET”) derived from renewable resources are also suitable. One embodiment encompasses a bio-based PET polymer that includes from about 25 to about 75 weight percent of a terephthalate component and from about 20 to about 50 weight percent of a diol component. At least about one weight percent of at least one of the terephthalate component and/or the diol component is derived from at least one bio-based material. According to a particular embodiment, the terephthalate component is selected from terephthalic acid, dimethyl terephthalate, isophthalic acid, and a combination thereof. In another embodiment, at least about ten weight percent of the terephthalate component is derived from at least one bio-based material. In one embodiment, the terephthalate component comprises at least about 70 weight percent of terephthalic acid. In yet another embodiment, at least about one weight percent, in another embodiment, at least about ten weight percent, of the terephthalic acid is made from at least one bio-based material. In another embodiment, the diol component is selected from ethylene glycol, cyclohexane dimethanol, and a combination thereof. In another embodiment, the diol component comprises at least about one weight percent of cyclohexane dimethanol. In another embodiment, at least about ten weight percent of the diol component is derived from at least one bio-based material.

Other sources of materials to form polymers derived from renewable resources include post-consumer recycled materials. Sources of synthetic post-consumer recycled materials can include plastic bottles, e.g., soda bottles, plastic films, plastic packaging materials, plastic bags and other similar materials which contain synthetic materials which can be recovered.

### III. Exemplary Synthetic Polymers

Olefins derived from renewable resources may be polymerized to yield polyolefins. Ethylene and propylene derived from renewable resources may be polymerized under the appropriate conditions to prepare polyethylene and/or polypropylene having desired characteristics for use in an oral care device. The polyethylene and/or polypropylene may be high density, medium density, low density, or linear-low density. Polyethylene and/or polypropylene may be produced via free-radical polymerization techniques, or by using Ziegler-Natta catalysis or Metallocene catalysts. Examples of such bio-sourced polypropylenes are described in U.S. Publication Nos. 2010/0069691, 2010/0069589, 2009/0326293, and 2008/0312485; PCT Application Nos. WO2010063947 and WO2009098267. Other olefins that can be derived from renewable resources include butadiene and isoprene. Examples of such olefins are described in U.S. Publication Nos. 2010/0216958 and 2010/0036173.

Such polyolefins being derived from renewable resources can also be reacted to form various copolymers, including for example impact-modified copolymers or impact copolymers. In a particular embodiment, the impact-modified copolymer can include impact-modified polypropylene (a copolymer of propylene and ethylene) and impact-modified polypropylene (a blend of isotactic polypropylene and polyisobutylene). Such copolymers and methods of forming same are contemplated and described for example in U.S. Pat. Nos. 7,488,789; 7,368,498; 7,259,211; 7,217,766; 7,109,269; 7,105,603; and 6,492,465.

In addition, the polyolefin derived from a renewable resource may be processed according to methods known in the art into a form suitable for the end use of the polymer. The polyolefin may comprise mixtures or blends with other polymers such as polyolefins derived from petrochemicals. Depending on the end use and form, the polyolefin may comprise other compounds such as inorganic compounds, fillers, pigments, dyes, antioxidants, UV-stabilizers, binders, surfactants, wetting agents, and the like.

Examples of bio-sourced polyamides and methods of forming are described in U.S. Publication No. 2010/0249282. Examples of bio-sourced PET and methods of forming are described in U.S. Publication Nos. 2009/0246430 and 2010/0028512.

It should be recognized that any of the aforementioned synthetic polymers (e.g., copolymers) may be formed by using a combination of monomers derived from renewable resources and monomers derived from non-renewable (e.g., petroleum) resources. For example, the copolymer can comprise propylene repeat units derived from a renewable resource and isobutylene repeat units derived from a petroleum source.

Certain synthetic polymers described herein derived at least in part from a renewable resource exhibit preferred characteristics. In one embodiment, these synthetic polymers can have a Melt Flow Index of about 12 g/10 min to about 100 g/10 min; and in another embodiment the synthetic polymers can have a Melt Flow Index of about 40 g/10 min to about 60 g/10 min. The Melt Flow Index can be determined applying the methodology set forth in ASTM D1238-10. one embodiment the density of at least a portion of the container (e.g., lid and/or base) comprising these synthetic polymers can be from about 0.85 g/cc to about 1.30 g/cc; in a certain embodiment the density can be from about 0.89 g/cc to about 1.14 g/cc; and in a certain embodiment the density can be from about 0.92 g/cc to about 0.95 g/cc. It will be appreciated that these portions of the oral care devices comprising the synthetic polymers can include other components, such as fillers, pigments etc., which could cause the density to be greater or less than the certain ranges noted herein. The density of the oral care devices comprising the synthetic polymers can be determined applying any suitable methodology, including for example, as set forth in ASTM D792-08.

IV. Oral Care Devices Comprising the Synthetic Polymer Derived from Renewable Resources

The present disclosure relates to oral care devices including a synthetic polymer derived from a renewable resource. The polymer has specific performance characteristics. The polymers derived from a renewable resource may be in any suitable form such as a handle, cleaning section or head portion, neck, elastomeric grip portion, elastomeric contact elements, elastomeric tongue cleaners and the like. The polymers derived from a renewable resource may also be used in components that are sold with oral care devices such as, a display for providing a variety of information, a travel case, a charger or stand, and the like. It is contemplated that the oral care devices can comprise a first synthetic polymer which is derived from a renewable resource such that anywhere from about 10% to about 100% of the device is formed from the first synthetic polymer.

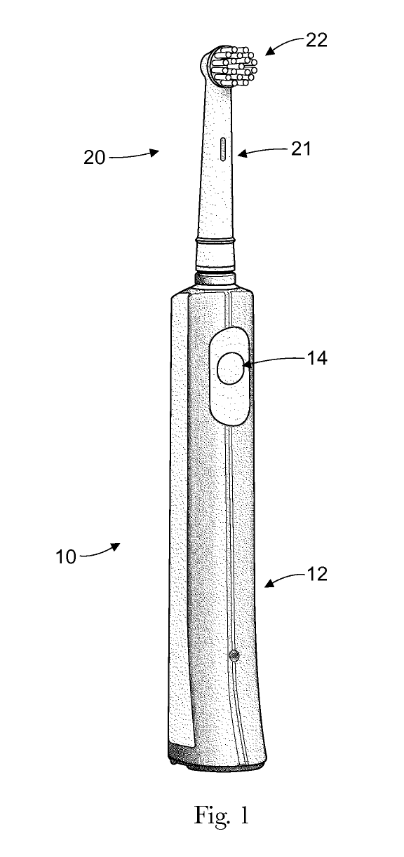

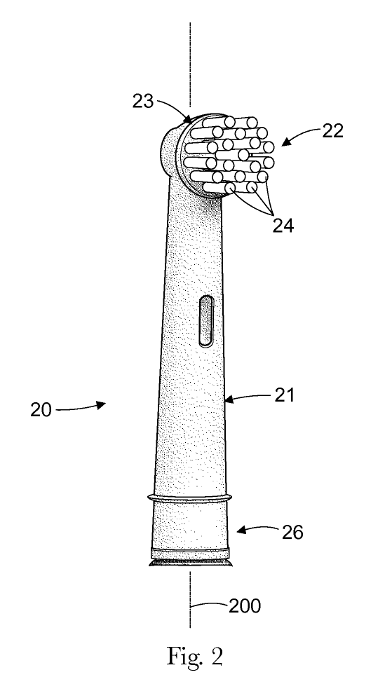

FIG. 1 illustrates an exemplary oral care device. In this embodiment, the oral care device is shown as a power or electric toothbrush 10. The electric toothbrush 10 includes a cleaning section 20 and a handle section 12. The cleaning section 20 is more particularly shown in FIG. 2, and is discussed in more detail below. The handle section 12 includes an interior cavity (not shown) which typically contains an electric drive such as a motor, batteries, mechanical linkages for connecting the electric drive to further mechanical linkages in the cleaning section 20, electronic components for controlling the electrical operation of the toothbrush 10, and the like. In many different embodiments, one or more of those interior components may be omitted, or replaced with other components. For example, a corded electrical power supply can supplant the need for batteries. A switch 14 may be used to turn the electric toothbrush 10 on and off, or otherwise to control operation of the electric toothbrush 10.

The electric drive in the handle section 12 imparts a motion to the mechanical linkages in the handle section 12. It may, for example, impart a rotary, oscillating, or rotary and oscillating motion to the mechanical linkages. The mechanical linkages in the handle section 12 are in turn coupled to additional mechanical linkages in the cleaning section 20, via a coupling member or the like. A suitable motor and mechanical linkage transmission system is disclosed for example in U.S. Patent Application Publication No. 2008/0307591 to Farrell et al., which is hereby incorporated by reference in its entirety. Movement of the combined mechanical linkages imparts a desired motion to a cleaning head portion 22 of the cleaning section 20 such that the cleaning head portion 22, or any component thereof, is caused to have a desired cleaning motion. Many different kinds of cleaning motions, including rotary, oscillating, vertical and/or horizontal sweeping and the like, may be used. Generally, as used herein, cleaning motion describes any desired or effective movement of the cleaning elements or bristles relative to other components in the toothbrush 10 to affect cleaning Handle sections 12 and mechanical linkages are well known to the skilled artisan. The cleaning section 20 may be configured for use with such existing handle sections or may be configured with new handle section types, as the case may be.

The cleaning section 20, shown in more detail by FIG. 2, may be replaceable and capable of being push-fitted onto the handle section 12. The cleaning section 20 includes an elongated housing or neck portion 21 extending along a longitudinal axis 200 and a cleaning head portion for insertion into the oral cavity. The longitudinal axis 200 may coincide with a longitudinal section of a drive shaft member of the mechanical linkages. At a handle end 26, the elongated housing 21 may include a profile ring having an inside contour complementary with an outside contour of the handle section 12. In this manner, the cleaning section 20 can be push-fitted onto the handle section 12 in a manner preventing relative rotation of the cleaning section 20 with respect to the handle section 12. A tab/slot, key/spline or other similar structure may be included in the corresponding contour surfaces to facilitate alignment of the cleaning section 20 with the handle section 12 and to further prevent relative rotation between the two. The cleaning head portion 22 is mounted such that it can in operation be driven into a rotation or oscillating rotation around a rotation axis when the cleaning section 20 is attached to the handle 12. Alternatively, the elongated housing 21 may be integrally formed with the handle section 12.

The illustrated cleaning head portion 22 has a substantially circular shape, although it may alternatively have a generally elliptical, rectangular, oblong, oval or other suitable shape. In some embodiments, the cleaning head portion 22 includes a carrier 23 which supports a plurality of contact elements 24 that are mounted to the carrier 23. Any suitable method of mounting the contact elements 24 to the carrier 23 may be used. For example, where the contact elements 24 comprise a plurality of bristles, methods such as hot tufting, gluing, stapling, and the like, may be utilized. As another example, where the contact elements 24 comprise a plurality of elastomeric elements, methods such as gluing, snap-fitting, welding, molding, etc. may be utilized.

The term “contact elements” is used to refer to any suitable element which can be inserted into the oral cavity. Some suitable elements include bristle tufts, elastomeric massage elements, elastomeric cleaning elements, massage elements, tongue cleaners, soft tissue cleaners, hard surface cleaners, combinations thereof, and the like. The contact elements 24 may comprise a wide variety of materials and may have a number of different configurations. Any suitable material and/or any suitable configuration may be utilized. For example, in some embodiments, the contact elements 24 may comprise tufts. The tufts may comprise a plurality of individual filaments which are securely attached to a cleaning element carrier. Such filaments may be polymeric and may include polyamide or polyester. The longitudinal and cross sectional dimensions of the filaments and the profile of the filament ends can vary. Additionally, the stiffness, resiliency and shape of the filament end can vary. Some examples of suitable dimensions include a length between about 3 centimeters to about 6 centimeters, or any individual number within the range. Additionally, the filaments may include a substantially uniform cross-sectional dimension of between about 100 to about 350 microns, or any individual number within the range. The tips of the filaments may be any suitable shape, examples of which include a smooth tip, a rounded tip, tapered and a pointed tip. In some embodiments, the filaments may include a dye which indicates wear of the filaments as described in U.S. Pat. No. 4,802,255. Other suitable examples of filaments are described in U.S. Pat. No. 6,018,840. In some embodiments, the contact element fields may comprise fins as described in U.S. Pat. No. 6,553,604, and U.S. Patent Application Publication Nos. 2004/0177462; 2005/0235439; and 2005/0060822. In some embodiments, the contact element fields may comprise a combination of fins and tufts.

In one embodiment, the head may comprise a variety of contact elements. For example, the cleaning head portion 22 may comprise bristles, abrasive elastomeric elements, elastomeric elements in a particular orientation or arrangement, e.g. pivoting fins, prophy cups, or the like. Some suitable examples of elastomeric cleaning elements and/or massaging elements are described in U.S. Patent Application Publication Nos. 2007/0251040; 2004/0154112; 2006/0272112; and in U.S. Pat. Nos. 6,553,604; 6,151,745. The cleaning elements may be tapered, notched, crimped, dimpled, or the like. Some suitable examples of these cleaning elements and/or massaging elements are described in U.S. Pat. Nos. 6,151,745; 6,058,541; 5,268,005; 5,313,909; 4,802,255; 6,018,840; 5,836,769; 5,722,106; 6,475,553; and U.S. Patent Application Publication No. 2006/0080794.

The cleaning head portion 22 may comprise a soft tissue cleanser constructed of any suitable material. The soft tissue cleanser may comprise any suitable soft tissue cleansing elements. Some examples of such elements as well as configurations of soft tissues cleansers on a toothbrush are described in U.S. Patent Application Nos. 2006/0010628; 2005/0166344; 2005/0210612; 2006/0195995; 2008/0189888; 2006/0052806; 2004/0255416; 2005/0000049; 2005/0038461; 2004/0134007; 2006/0026784; 20070049956; 2008/0244849; 2005/0000043; 2007/140959; and U.S. Pat. Nos. 5,980,542; 6,402,768; and 6,102,923.

For those embodiments which include an elastomeric element on a first side of the head and an elastomeric element on a second side of the head (opposite the first), the elastomeric elements may be integrally formed via channels or gaps which extend through the material of the head. These channels or gaps can allow elastomeric material to flow through the head during an injection molding process such that both the elastomeric elements of the first side and the second side may be formed in one injection molding step.

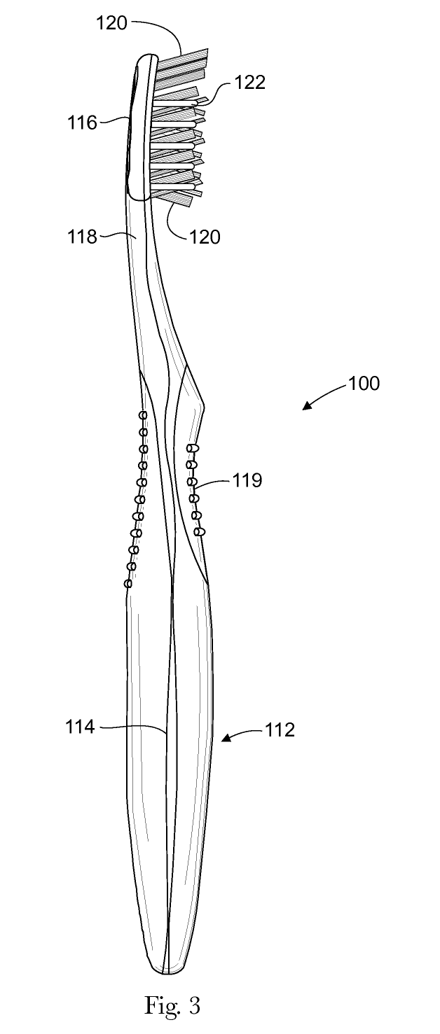

FIG. 3 illustrates an exemplary oral care device. In this embodiment, the oral care device is shown as a manual toothbrush 100. Toothbrush 100 includes a body 112 that includes a handle 114, a cleaning head portion 116, and a neck 118 between the handle 114 and the cleaning head portion 116. In one embodiment, toothbrush 100 also includes a grip portion 119. Contact elements 120 which include at least one filament 122, extend from cleaning head portion 116 of body 112. The various portions of toothbrush 100 can be formed from any of the synthetic polymers, individually or in combination, as described above.

The oral care devices described herein can be partially or fully covered with a package. The package may comprise a variety of materials including, but not limited to, thermoplastic films, nonwovens, wovens, foils, fabrics, papers, cardboard, plastics, and combinations thereof. In certain embodiments, the package comprises a synthetic polymer (e.g., a polyolefin) derived form a renewable resource. Such overwrap package can be formed from any of the synthetic polymers, individually or in combination, as described herein.

V. Oral Care Dispensers, Dental Floss and Backing Material for Tooth Whitening Devices Comprising the Synthetic Polymer Derived from Renewable Resources

The present disclosure relates to oral care dispensers including a synthetic polymer derived from a renewable resource. The polymer has specific performance characteristics. The polymers derived from a renewable resource may be in any suitable form such as a dispenser body, collar, neck, closure, cap and the like. It is contemplated that the oral care dispensers can comprise a first synthetic polymer which is derived from a renewable resource such that anywhere from about 10% to about 100% of the device is formed from the first synthetic polymer.

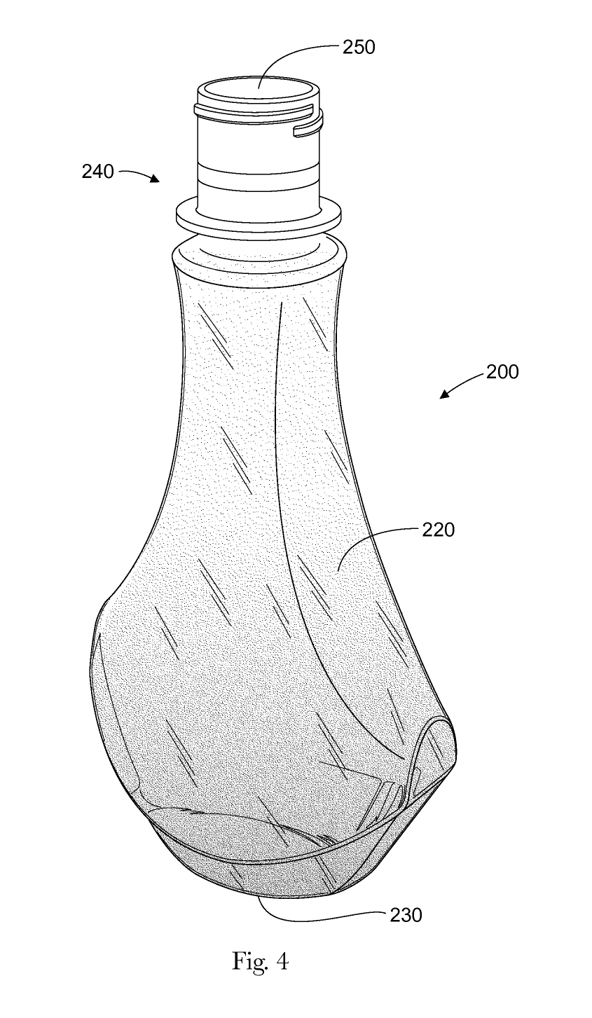

FIG. 4 illustrates an exemplary oral care dispenser. In this embodiment, the oral care dispenser is shown as a container for dispensing dentifrice, indicated generally as 200. The dispenser 200 includes a container body 220, a closed bottom end 230 and a closure 240. In one embodiment, the oral care dispenser 200 can be stored in an upright position when not in use. In another embodiment, the oral care dispenser 200 can be stored in an inverted position with closure 240 down, as seen in FIG. 4. In one embodiment, the container body 220 may be blow molded from a plastic material and can be a blow molded tube or bottle of varying shape or size for containing an oral care composition. In one example, container body 220 can be constructed by an extrusion blow molding method using a first synthetic polymer which is derived from a renewable resource. Other suitable methods, such as stretch blow molding or injection molding, can also be used in the manufacture of container body 220. Suitable methods of manufacturing a container by blow molding are disclosed in U.S. Pat. No. 5,839,616 and U.S. Patent Application No. 2008/0150198, which are hereby incorporated by reference in their entirety.

The present disclosure also relates to dental floss including a synthetic polymer derived from a renewable resource. The polymer has specific performance characteristics. It is contemplated that the dental floss can comprise a first synthetic polymer which is derived from a renewable resource such that anywhere from about 10% to about 100% of the floss is formed from the first synthetic polymer.

Dental floss is a tool used by many people to help remove debris and plaque from between their teeth. Over the years, floss has developed from a simple uncoated silk fiber, to an uncoated nylon fiber, to coated and uncoated fibers of many varieties. Dental floss can be coated for many reasons, including strengthening of the fiber, adding abrasive material to help with cleaning, and lowering the friction between the fiber and the teeth so that it is easier to use the floss. In one embodiment, the dental floss is comprised of a thin fibrous substrate having properties (strength, dimensions, safety) allowing it to be used in an oral cavity to remove food and plaque from the teeth. The floss is inserted between the teeth and scrapes along the sides of the teeth, especially close to the gums. In one embodiment, the fibrous substrate comprising the dental floss can be in the form of an individual fiber or in the form of a yarn comprising a plurality of such fibers (multi-fiber yarn); wherein the fibers may be individual distinct fibers, fibers that are partially or completely bonded together, or combinations thereof.

A fibrous substrate in the form of a single fiber may have any suitable cross-sectional shape, for example circular or rectangular. In addition a fiber may be a multi-component fiber such as a bi-component fiber, tri-component fiber, etc. In one embodiment, a fiber or a multi-fiber yarn can be made of any material suitable for application in the oral cavity. Some common polymers used to make fibers suitable for the oral cavity include, for example, polytetrafluorethylene (PTFE), nylon, polyether block amide, polypropylene, polyethylene, ultra-high molecular weight polyethylene, and combinations thereof. In one embodiment, a fiber or a multi-fiber yarn can be formed from any of the synthetic polymers, individually or in combination, as described above.

The present disclosure also relates to a backing material for a tooth whitening device where the backing material includes a synthetic polymer derived from a renewable resource. The polymer has specific performance characteristics. It is contemplated that the backing material can comprise a first synthetic polymer which is derived from a renewable resource such that anywhere from about 10% to about 100% of the backing material is formed from the first synthetic polymer.

In one embodiment, the strip of backing material comprises polyethylene. The strip of material is generally less than about 1 mm thick, in another embodiment less than about 0.05 mm thick, and in another embodiment from about 0.001 to about 0.03 mm thick. In one embodiment, a polyethylene strip of material is less than about 0.1 mm thick and in another embodiment from about 0.005 to about 0.02 mm thick.

The shape of the strip of material is any shape and size that covers the desired oral surface. Preferably the strip of material has rounded corners. Rounded corners is defined as not having any sharp angles or points. In one example, the length of the strip of material is from about 2 cm to about 12 cm and in another embodiment from about 4 cm to about 9 cm. The width of the strip of material will also depend upon the oral surface area to be covered. In one example, the width of the strip of material is from about 0.5 cm to about 4 cm and in another embodiment from about 1 cm to about 2 cm.

The strip of material may contain shallow pockets. When the oral care substance is coated on a strip of material, additional oral care substance fills shallow pockets to provide reservoirs of additional oral care substance. Additionally, the shallow pockets help to provide texture to the delivery system. The film will preferably have an array of shallow pockets. Generally, the shallow pockets are approximately 0.4 mm across and 0.1 mm deep. When shallow pockets are included in the strip of material and oral care substances are applied to it in various thicknesses, the overall thickness of the delivery system is generally less than about 1 mm.

This relatively low stiffness enables the strip of material to cover the contours of the oral surface with very little force being exerted. That is, conformity to the contours of the oral surface of the wearer's mouth is maintained because there is little residual force within the strip of material to cause it to return to its shape just prior to its application to the oral surface, i.e. substantially flat. The strip of material's flexibility enables it to contact soft tissue over an extended period of time without irritation. The strip of material does not require pressure forming it against the oral surface. In one embodiment, the backing material can be formed from any of the synthetic polymers, individually or in combination, as described above.

### VI. Communicating a Related Environmental Message a Consumer

The present disclosure may further comprise a related environmental message or may further comprise a step of communicating a related environmental message to a consumer. The related environmental message may convey the benefits or advantages of the oral care device comprising a polymer derived from a renewable resource. The related environmental message may identify the oral care device as: being environmentally friendly or Earth friendly; having reduced petroleum (or oil) dependence or content; having reduced foreign petroleum (or oil) dependence or content; having reduced petrochemicals or having components that are petrochemical free; and/or being made from renewable resources or having components made from renewable resources. This communication is of importance to consumers that may have an aversion to petrochemical use (e.g., consumers concerned about depletion of natural resources or consumers who find petrochemical based products unnatural or not environmentally friendly) and to consumers that are environmentally conscious. Without such a communication, the benefit of the present disclosure may be lost on some consumers.

The communication may be effected in a variety of communication forms. Suitable communication forms include store displays, posters, billboard, computer programs, brochures, package literature, shelf information, videos, advertisements, internet web sites, pictograms, iconography, or any other suitable form of communication. The information could be available at stores, on television, in a computer-accessible form, in advertisements, or any other appropriate venue. Ideally, multiple communication forms may be employed to disseminate the related environmental message.

The communication may be written, spoken, or delivered by way of one or more pictures, graphics, or icons. For example, a television or internet based-advertisement may have narration, a voice-over, or other audible conveyance of the related environmental message. Likewise, the related environmental message may be conveyed in a written form using any of the suitable communication forms listed above. In certain embodiments, it may be desirable to quantify the reduction of petrochemical usage of the present oral care device compared to oral care devices that are presently commercially available.

The related environmental message may also include a message of petrochemical equivalence. Many renewable, naturally occurring, or non-petroleum derived polymers are known. However, these polymers often lack the performance characteristics that consumers have come to expect when used in oral care devices. Therefore, a message of petroleum equivalence may be necessary to educate consumers that the polymers derived from renewable resources, as described above, exhibit equivalent or better performance characteristics as compared to petroleum derived polymers. A suitable petrochemical equivalence message can include comparison to an oral care device that does not have a polymer derived from a renewable resource. For example, a suitable combined message may be, “Toothbrush Product Brand A with an environmentally friendly material is just as effective as Toothbrush Product Brand B.” This message conveys both the related environmental message and the message of petrochemical equivalence.

VII. Method of Making an Oral Care Device Having a Polymer Derived from a Renewable Resource

The present disclosure further relates to a method for making an oral care device comprising a synthetic polymer derived from a renewable resource. The method comprises the steps of providing a renewable resource; deriving an intermediate monomer from the renewable resource; polymerizing the intermediate monomer to form a synthetic polymer and incorporating the synthetic polymer into an oral care device. The present disclosure further relates to providing one or more of the oral care devices to a consumer and communicating reduced petrochemical usage to the consumer. The synthetic polymer derived from renewable resources may undergo additional process steps prior to incorporation into the oral care device.

In accordance with another embodiment, a method for making an oral care device comprises the steps of providing a first renewable resource, deriving a first intermediate monomeric compound from the first renewable resource, polymerizing the first intermediate monomeric compound to form a first polymer that is synthetic, and incorporating the first polymer into an oral care device. The oral care device includes a handle and a cleaning section. At least one of the handle and the cleaning section or head portion exhibits a bio-based content from about 10% to about 100% using ASTM D6866-10, method B.

VIII. Validation of Polymers Derived from Renewable Resources

A suitable validation technique is through ¹⁴C analysis. A small amount of the carbon dioxide in the atmosphere is radioactive. This ¹⁴C carbon dioxide is created when nitrogen is struck by an ultra-violet light produced neutron, causing the nitrogen to lose a proton and form carbon of molecular weight 14 which is immediately oxidized to carbon dioxide. This radioactive isotope represents a small but measurable fraction of atmospheric carbon. Atmospheric carbon dioxide is cycled by green plants to make organic molecules during photosynthesis. The cycle is completed when the green plants or other forms of life metabolize the organic molecules, thereby producing carbon dioxide which is released back to the atmosphere. Virtually all forms of life on Earth depend on this green plant production of organic molecules to grow and reproduce. Therefore, the ¹⁴C that exists in the atmosphere becomes part of all life forms, and their biological products. In contrast, fossil fuel based carbon does not have the signature radiocarbon ratio of atmospheric carbon dioxide.

Assessment of the renewably based carbon in a material can be performed through standard test methods. Using radiocarbon and isotope ratio mass spectrometry analysis, the bio-based content of materials can be determined. ASTM International, formally known as the American Society for Testing and Materials, has established a standard method for assessing the bio-based content of materials. The ASTM method is designated ASTM D6866-10.

The application of ASTM D6866-10 to derive a “bio-based content” is built on the same concepts as radiocarbon dating, but without use of the age equations. The analysis is performed by deriving a ratio of the amount of organic radiocarbon (¹⁴C) in an unknown sample to that of a modern reference standard. The ratio is reported as a percentage with the units “pMC” (percent modern carbon).

The modern reference standard used in radiocarbon dating is a NIST (National Institute of Standards and Technology) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). The AD 1950 reference represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn could give a radiocarbon signature near 107.5 pMC.

Combining fossil carbon with present day carbon into a material will result in a dilution of the present day pMC content. By presuming 107.5 pMC represents present day biomass materials and 0 pMC represents petroleum derivatives, the measured pMC value for that material will reflect the proportions of the two component types. A material derived 100% from present day soybeans would give a radiocarbon signature near 107.5 pMC. If that material was diluted with 50% petroleum derivatives, for example, it would give a radiocarbon signature near 54 pMC (assuming the petroleum derivatives have the same percentage of carbon as the soybeans).

A biomass content result is derived by assigning 100% equal to 107.5 pMC and 0% equal to 0 pMC. In this regard, a sample measuring 99 pMC will give an equivalent bio-based content value of 92%.

It is presumed that all materials are present day or fossil in origin and that the desired result is the amount of biobased component “present” in the material, not the amount of biobased material “used” in the manufacturing process.

In one embodiment, at least one of the handle and the cleaning section or head portion of an oral care device exhibits a bio-based content value from about 10% to about 100% using ASTM D6866-10, method B. In another embodiment, at least one of the handle and the cleaning section or head portion of an oral care device exhibits a bio-based content value from about 25% to about 100% using ASTM D6866-10, method B. In yet another embodiment, at least one of the handle and the cleaning section or head portion of an oral care device exhibits a bio-based content value from about 50% to about 100% using ASTM D6866-10, method B.

In order to apply the methodology of ASTM D6866-10 to determine the bio-based content of any of the components (e.g. handle, cleaning section) of the oral care device, a representative sample of the component must be obtained for testing. In one embodiment, the entire component can be ground into particulates less than about 20 mesh using known grinding methods (e.g., Wiley® mill), and a representative sample of suitable mass taken from the randomly mixed particles.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An oral care device comprising:
a) a body formed at least partially from a first polymer derived from a first renewable resource via at least one first intermediate compound, wherein the first polymer is synthetic, and wherein the first intermediate compound is monomeric, and wherein the first polymer is disposed in or incorporated into one or more components of the body, the components selected from a group consisting of a handle, a cleaning head portion, a neck and a grip portion; and
b) at least one contact element extending from the body;
wherein at least one component of the body has a bio-based content of about 10% to about 100% using ASTM D6866-10, method B.

2. The oral care device of claim 1, wherein the at least one component of the body has a density of about 0.85 g/cc to about 0.99 g/cc.

3. The oral care device of claim 2, wherein the at least one component of the body has a density of about 0.89 g/cc to about 0.96 g/cc.

4. The oral care device of claim 1, wherein the first polymer has a Melt Flow Index of from about 12 g/10 min to about 100 g/10 min.

5. The oral care device of claim 4, wherein the first polymer has a Melt Flow Index of from about 40 g/10 min to about 60 g/10 min.

6. The oral care device of claim 1, wherein at least one component of the body has a bio-based content of from about 25% to about 100% using ASTM D6866-10, method B.

7. The oral care device of claim 6, wherein at least one component of the body has a bio-based content of from about 50% to about 100% using ASTM D6866-10, method B.

8. The oral care device of claim 1, wherein the first polymer is a copolymer comprising monomers selected from the group consisting of propylene, ethylene, butadiene and combinations.

9. The oral care device of claim 1, wherein the first polymer is at least partially derived from a renewable resource via a first primary intermediate compound and a first secondary intermediate compound, wherein the first secondary intermediate compound is formed prior to the first primary intermediate compound.

10. The oral care device of claim 1, wherein the first secondary intermediate compound is selected from the group consisting of organic acids, sugars, monofunctional alcohols, polyfunctional alcohols, organic aldehydes, organic esters, and combinations thereof.

11. The oral care device of claim 1, wherein the first polymer is a polyolefin selected from the group consisting of polypropylene, polyethylene, and combinations thereof.

12. A package comprising the oral care device of claim 1, the package having a label for communication of an environmental message to a consumer.

13. An oral care device, comprising:
a) a handle;
b) a cleaning section having at least one contact element extending therefrom; and
c) a first polymer derived from a first renewable resource via at least one first intermediate compound, the first polymer being synthetic, and the first intermediate compound being monomeric, and at least one of the handle and the cleaning section having a bio-based content of about 10% to about 100% using ASTM D6866-10, method B.

14. The oral care device of claim 13, wherein at least one of the handle and the cleaning section has a bio-based content of from about 25% to about 100% using ASTM D6866-10, method B.

15. The oral care device of claim 13, wherein the first polymer is a copolymer comprising monomers selected from the group consisting of propylene, ethylene, butadiene and combinations thereof.

16. The oral care device of claim 13, wherein the first polymer is at least partially derived from a renewable resource via a first primary intermediate compound and a first secondary intermediate compound, wherein the first secondary intermediate compound is formed prior to the first primary intermediate compound.

17. The oral care device of claim 13, wherein the first secondary intermediate compound is selected from the group consisting of organic acids, sugars, monofunctional alcohols, polyfunctional alcohols, organic aldehydes, organic esters, and combinations thereof.

18. The oral care device of claim 13, wherein the first polymer is a polyolefin selected from the group consisting of polypropylene, polyethylene, and combinations thereof.

19. A package comprising the oral care device of claim 13, the package having a label for communication of an environmental message to a consumer.

20. A blow molded oral care dispenser for dispensing an oral care composition comprising:
a body including a closed bottom end, the body formed at least partially from a first polymer derived from a first renewable resource via at least one first intermediate compound, wherein the first polymer is synthetic, and wherein the first intermediate compound is monomeric, and wherein the body has a bio-based content of about 10% to about 100% using ASTM D6866-10, method B.
